(19) United States
(12) Patent Application Publication
(10) Pub. No.: US 2011/0253759 A1
(43) Pub. Date: Oct. 20, 2011

(54) Handy hangers for tools

(76) Inventors: Robert Scalese, Big Sandy, MT (US); Daniel Martin Manning, Bigfork, MT (US)

(21) Appl. No.: 13/066,381

(22) Filed: Apr. 13, 2011

Related U.S. Application Data
(60) Provisional application No. 61/342,514, filed on Apr. 15, 2010.

(51) Int. Cl. F16B 45/00; A45F 3/00

(52) U.S. Cl. 224/660; 248/303

(57) ABSTRACT

A device that carries, holds, and secures hand tools, power tools and other devices & objects (squirt bottles, flashlights, calking guns, hair dry blowers, etc) made from a single pliable type material. The device carrier/holder is sturdy and rigid for securely holding hand tools or power tools or other devices and objects and such device can be readily shaped and re-shaped by the user by applying their own hand strength in order to better fit the many shapes, sizes, weights, models, makes, styles, etc of hand tools, power tools, and other objects that are used. The device carrier and holder can be placed and or hung from the users belts, pockets, waist bands, tool belts, carpenter aprons, aprons, electrician tool belts, plumber tool belts, tool bags, tool pouches and other professional tool belts and or placed and or hung over the rim of a tool bucket, cans, paint cans, arms on ladders, the edges of tool boxes, work bench slats, the slats in slat-wall display walls, (but not limited to just these) and many more not mentioned. Allowing the user to place the tool carrier and holder in the most assessable, convenient, and handy place for carrying, accessing, and holding the tools they use. The device carrier/holder provides 2 rounded surfaces so tools & objects slide easily into section of it that holds the tools, devices, and objects. The device carrier and tool holder is made from a single type of material creating a tool carrier and tool holder that has no mechanical parts to break, or to become loose, and fail or need repaired.

### CROSS-REFERENCE TO RELATED APPLICATIONS

This application claims the benefit of provisional patent application: APPLICATION NUMBER 61/342,514 FILED Apr. 15, 2010 CONFIRMATION NO. 2376

FILING RECEIPT 00000000042100642 This application was filed by the present inventors.

### FEDERALLY SPONSORED RESEARCH

None

### SEQUENCE LISTING

None

### BACKGROUND

### Prior Art

The following is a tabulation of some prior art that presently appears relevant:

U.S. PATENTS

| Patent Number | Kind Code | Issue Date | Patentee |
|---|---|---|---|
| D565,396 | S | Apr. 01, 2008 | Wipf |
| D608,086 | S | Jan. 19, 2010 | Johnson, Rutz, Childs |
| 275,527 | | Sep. 18, 1984 | Gee |
| 6,454,147 | B1 | Sep. 24, 2002 | Marks |
| 7,077,303 | B2 | Jan. 16, 2006 | Zega |
| 6,062,449 | | May 16, 2000 | Kahn |
| 5,687,892 | | Nov. 18, 1997 | Johns |

People performing tasks often need and require using and applying hand tools, power tools and other devices & objects (squirt bottles, flashlights, calking guns, hair dry blowers, etc) to aid them in performing their tasks. They seek convenient ways to carry, store, and hold the tools, devices, and objects they use. Often times in addition to the hand and power tools people require the use of climbing equipment, boom lifts, ladders, stools, scaffolding, hoisted baskets, etc and often times the work areas are crowded spaces like crawl spaces, attics, closets, elevator shafts, etc, which limits the space to carry, handle and hold tools. These conditions and general work conditions require tool carriers and holders to be adaptable and or convenient and or accessible by the worker. Tool carriers and holders often provide the person using the tool with the ability to keep their hands free when not using a tool, as in climbing ladders or performing various other tasks, but also keeps the tool accessible so they can easily retrieve it when they need the tool.

Now days there is a vast variety of hand tools, power tools and other devices & objects with many shapes, sizes, weights, models, makes, styles, etc. and uses. This makes the current tool holders limited for carrying, holding, and securing the large variety of hand tools, power tools and other devices & objects used today. Johnson, Rutz, Childs along with Marks, and Kahn all have tool carrying & holding devices that limits the size and shape of the tools that fit-in or hangs-in their devices. If the tools in use are heavier, fatter, lighter, and or smaller, the tool often times the tool in use does not fit at all or fits very poorly in these types of tool carriers/holders. These tool carrier/holders are also made of up of many parts and pieces, having a mechanical aspect to them that fails at some point. Tools drop and get damaged and this also creates a dangerous area by which people can get injured by falling tools. And these tool carriers/holders all have narrower belt type hanging parts, this limits the tool carrier/holder to disperse the weight of the tool along the object it is attached and hanging from, usually a waist band or belt.

A person using hand tools, power tools and other devices & objects often times needs to quickly and easily place the device being used into the tool carrier/holder section of the tool holder they are using. Gee and Wipf devices have no lip or bump-outs on the part of the tool holder that holds the tools which makes it awkward to replace the tool in the tool holder. This causes tools to miss being replaced into the holder section resulting in tools falling and becoming damaged plus creates a dangerous area for anyone close to the falling tool.

Many tool holders attach by running a belt type device through loops in the tool holder. This limits the person using hand tools, power tools and other devices & objects ability to quickly use or remove the tool holder from the device it hangs from, typically a waist band or belt. Zega and Johns both have devices that belts have to be threaded through the tool holder prior to use. This is limiting and time consuming to attach or un-attach the tool holder making it inconvenient for the user to easily switch the tool holder to another place, area, belt, etc.

Thus, all the tool holders known are limited by a number of disadvantages:
a) the part of the tool carrier/holder that the tool hangs in or fits in have limited size and shape limiting the size and shape of tools they carry or hold. None have the ability to be modified, shaped and reshaped by the user to fit the large variety of hand tools, power tools and other devices & objects.
b) many of the tool carrier/holders are composed of several types, shapes, parts, and pieces of materials. Making them mechanical and therefore they fail and break at some point in time which causes tools to fall resulting in tool damage and creating a dangerous area around the tool user.
c) tool carriers/holders have narrow hanging sections or parts, clip like, from which the holder is attached to the person or on other devices. Resulting is poor weight displacement of the hand tools, power tools and other devices & objects when placed in the holder.
d) many of the tool carrier/holders available lack a lip section and bump-out section on the part of the tool holder that holds the tools. This makes placing and replacing the tools in this part of the holder to be awkward. Causing tools to miss being replaced in the tool carrier/holder and fall resulting in tool damage and creating a dangerous area around the tool user.
e) the tool carrier/holders in use today many times require the user to thread a belt through loops in order to attach the tool carrier/holder to the user. This results in a tool holding type device that is more inconvenient when needing to switch to another belt or device.

### SUMMARY

The object of the invention is providing people using hand tools, power tools and other devices & objects (squirt bottles, flashlights, calking guns, hair dry blowers, etc) with a device that carries, holds, and secures this large variety of objects. By the user being able to adjust the fit, modify, shape, and reshape the device that carries, holds, and secures the tool/object in use. By the device hanging and or attaching onto the users belts, pockets, waist bands, tool belts, carpenter aprons, aprons, electrician tool belts, plumber tool belts, tool belt pouches, other professional tool belts, buckets, cans, ladders, tool boxes, work bench slats, slat wall display walls, and many more objects and devices.

### ADVANTAGES

Accordingly several advantages are as follows: to provide people using hand tools, power tools and other devices & objects (squirt bottles, flashlights, calking guns, hair dry blowers, etc) with a device carrier/holder, that can be modified, shaped and or reshaped to better fit the multiple sizes, weights, models, makes, and styles of these tools/objects being used by the user, that can disperse the weight of tools/devices/objects being used by users more evenly along the users body verses one single small contact point, that provides rounded surfaces so the tools/devices/objects used by users slide easily into the holder, that can be made from a single type of material reducing mechanical failure and breakage of tool carriers/holders. Results in a more secure & diversified device carrier/holder allowing the user greater utility from its beneficial features. Other advantages become more apparent from reviewing the drawings and descriptions.

### DRAWINGS

### Figures

In the drawings it shows 1 main embodiment of the invention and 3 variations of the main embodiment. Closely related parts and shapes of the 3 variations have the same reference numerals but different alphabetic suffixes. All drawing reflect an approximate 45 degree view.

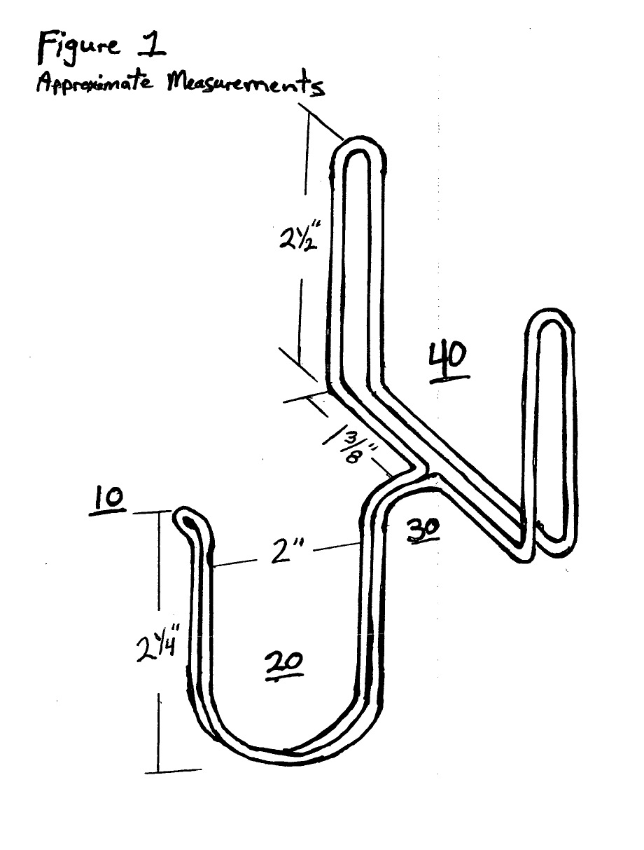

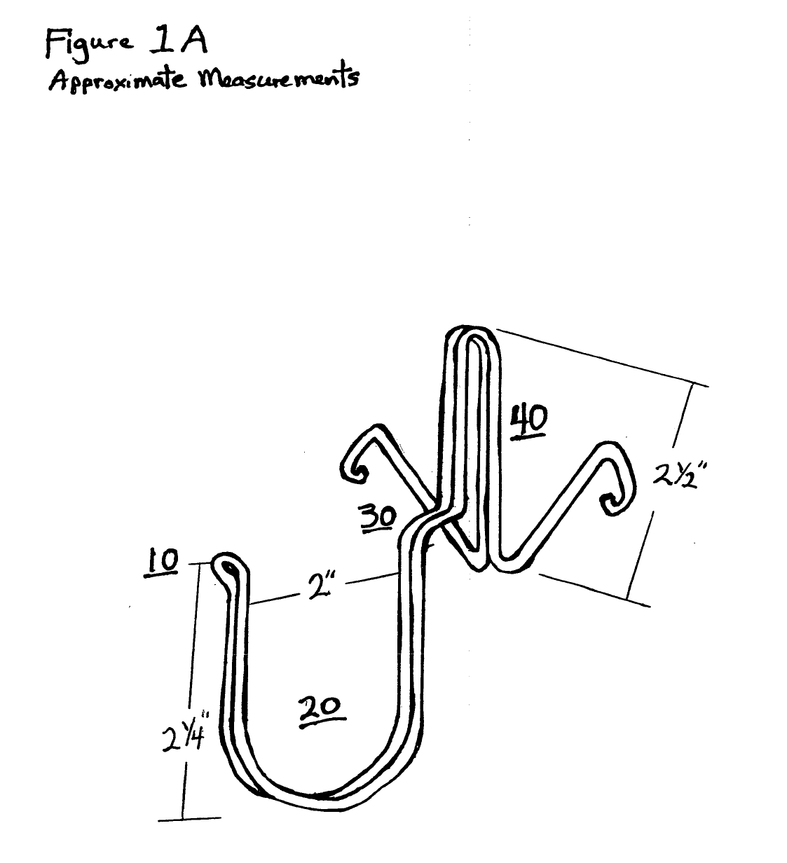

FIG. 1 shows the main embodiment of the invention.

FIG. 1A shows the first variation of the invention.

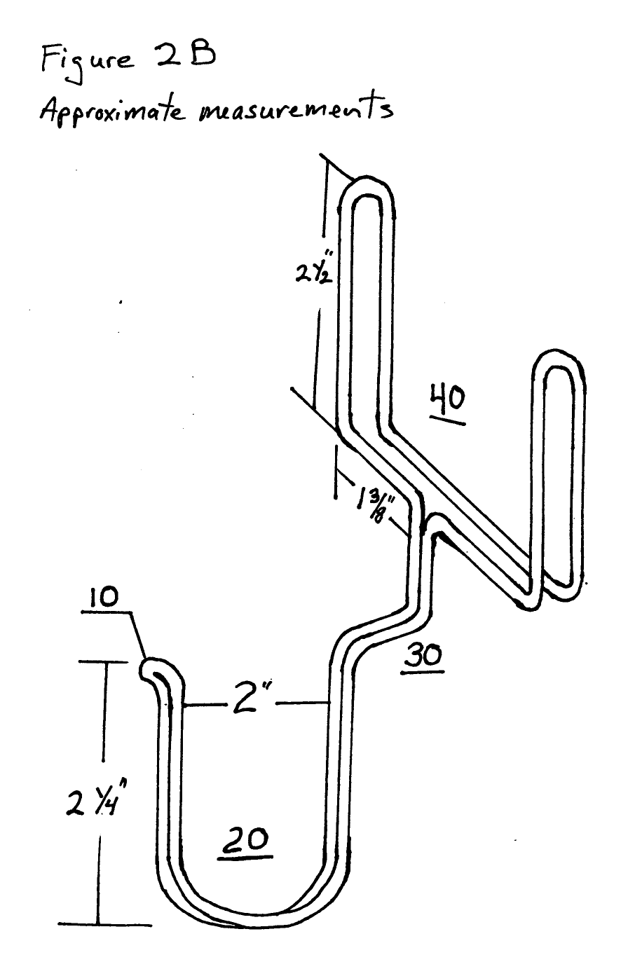

FIG. 2B shows the second variation of the invention.

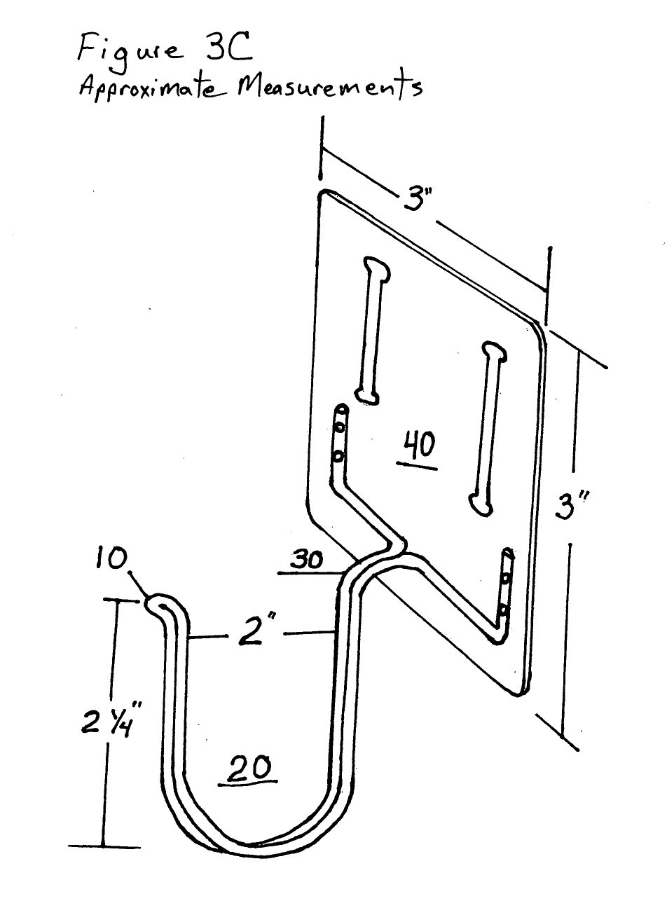

FIG. 3C shows the third variation of the inventions.

### DRAWING REVERENCE NUMERALS

10 Lip Section of the hook shape that holds tools, devices, & objects
20 Belly and Hook Section that holds tools, devices, & objects
30 Bump-out Section away from the Hanger Section
40 Hanger Section of the device holder that attaches and or fits over users belts, pockets, waist bands, tool belts, carpenter aprons, aprons, electrician tool belts, plumber tool belts, tool belt pouches, other professional tool belts, buckets, cans, ladders, tool boxes, work bench slats, and slat wall display walls

### DETAILED DESCRIPTION

### FIG. 1 Main Embodiment

The invention device is presently made by bending various gages of wire (currently #9, #8, #7, #6 size), but it is not limited to wire neither is it limited to these wire sizes. The entire invention device is made of material that is pliable (similar to wire type material) and using your hands and strength a person using the device can make minor changes to the device. But the material is rigid as well so it maintains its basic shape when in use. The device can be created using various material compositions such as resins, plastics, compounds, composites, and from the many different fiber materials like carbon fiber and fiber glass to name a few. In addition, the device can be made from various material shapes like flat, round, rectangle, square, triangular, etc. At some point it could be made by injection molding techniques as well. As the product sells in the market the shape of the material, type of material, method of construction, and material composition will be narrowed down or determined.

The invention device can be scaled up or scaled down in size depending on the end use. The size reflected in the FIG. 1 and the 3 variations are currently used and shown since this size fits the widest variety of devices as of to date. The size may and can be altered for more specific use(s).

Referring to the FIG. 1, labeled as such, start at the lip section, reference no. 10, this shows the small lip that is approximately 3/16 inch radius bent out from straight. The belly and hook section, reference no. 20, is approximately 2¼ inch from the lip to the belly or bottom of the hook which is bent in approximately a 2 inch half circle. Continuing up from the belly or bottom of the hook approximately 2¼ inch to the beginning of the bump-out section, reference no. 30. The bump-out is around 3/16 inch radius and ends at the start of the hanger section, reference no. 40. The hanger section, reference no. 40, the material (wire in this diagram) are separated by bending them 90 degree in opposite directions. Measure approximately 1⅜ inch from separation and bend 90 degrees up, measure about 2½ inches and make a 180 degree bend back down with an approximate ⅜ inch to ½ inch half circle, measure approximately 2½ inch and turn the material 90 degrees toward each other to meet each other and secure the ends together.

This device carrier/holder can be reduced in the size/shape to become smaller for smaller tools or increased in size/shape to become larger for larger tools. Thus increasing its capability to carry, hold and secure a large variety of tools, devices, and objects by utilizing its basic shape and material.

### OPERATION

### FIG. 1 Main Embodiment

The invention can be used one method of two methods or by using both methods.

The manner of using the invention using method 1 is by slipping or hanging the hanger section, reference no. 40, over the rim of tool buckets, cans, paint holder arms on ladders, the edges of tool boxes, tool bags, work bench slats, and the slats in slat-wall display walls. Therefore allowing the tool to be held in a manner and or place and or display that is most convenient for the user. Drop or place the hand tool, power tool and other device & object (squirt bottles, flashlights, calking guns, hair dry blowers, etc) between the lip, reference no. 10 and the bump out, reference no. 30, and allow the device to slide and slip along these rounded smooth surfaces down into the belly of the hook section, reference no. 20. If the tool fit is loose, adjust the fit. Using your hands bend the hook section, reference no 20, to become smaller, narrower, larger or wider to better fit the device being held.

The manner of using the invention using method 2 is by slipping, placing, hanging, the hanger section, reference no. 40, upon the users belts, pockets, waist bands, tool belts, carpenter aprons, aprons, electrician tool belts, plumber tool belts, tool belt pouches, other professional tool belts.

The invention can be hung at any points around a persons body, usually it's hung on either side of the body and can be moved and positioned to hang more in the front or back of the body depending on the person, the task, user preferences, etc. Therefore the person places the device carrier/holder in the most convenient place along their belts, pockets, waist bands, tool bags, aprons, tool pouches and or various work and or tool belts for them to comfortably carry and hold the tools they apply to their work.

Once hanger section, reference no. 40, is securely placed, then drop or place the hand tool, power tool and other device & object (squirt bottles, flashlights, calking guns, hair dry blowers, etc) between the lip, reference no. 10 and the bump out, reference no. 30, and allow the device to slide and slip along these rounded smooth surfaces down into the belly of the hook section, reference no. 20. If the tool fit is loose, adjust the fit. Using your hands bend the hook section, reference no 20, to become smaller, narrower, larger or wider to better fit the device being held.

### FIG. 1A, 2B, 3C

### Additional Variations of the Invention

Additional embodiments are shown in FIGS. 1A, 2B, and 3C. In FIGS. 1A and 2B cases the types of material that can be used, the shapes of the material that can be used, and the shape of the lip section, reference no. 10, hook belly section, reference no. 20, and bump-out section, reference no. 30, all remain unchanged. FIG. 1A modifies the hanger section, reference no. 40, into a single type hanger with 2 winged out arms in the back of the hanger that spread support out on the surface it rest against and the device pulls against. FIG. 1A works with smaller and lighter type hand tool, power tool and other device & object (squirt bottles, flashlights, calking guns, hair dry blowers, etc) which have little weight that needs to be dispersed. FIG. 2B adds length to the area between the bump-out section, reference no. 30 and the hanger section, reference no. 40 for the purpose of allowing the device carrier/holder to hang the hand tool, power tool and other device & object (squirt bottles, flashlights, calking guns, hair dry blowers, etc) in a lower position. FIG. 3C replaces most of the hanger section, reference no. 40, with a piece of approximate 3 inch by 3 inch material (leather is typically used but many other type of material can be used such a canvas, polymers, plastics, and many others). This material has 2 slits approximate 2¼ inch long used for threading a device through it to support hanging the device carrier/holder. The FIG. 3C diagram shows the hanger section, reference no. 40, being a leather piece and attaching to the bump-out section, reference no. 30, by bending the 2 materials coming from the bump-out, reference no. 30, in opposite directions at 90 degree angles and then measuring approximately an inch and bending two ends 90 degrees up, measuring approximately 1½ inches and using these ends to rivet and attach the leather piece.

1. The invention has the following advantages:
(C1)—The entire invention device is made of material that is pliable (similar to wire type material) and using hands and strength the user can adjust, modify, shape and reshape sections of the device carrier/holder. But, as well, the material is rigid so it maintains its shape. The device has a hook section, reference no. 20, that secures hand tools, power tools and other devices & objects (squirt bottles, flashlights, calking guns, hair dry blowers, etc) within this hook shape. Whereby the material and shape allows the device user to adjust, modify, shape and re-shape the hook section, reference no. 20, multiple times by applying hand strength in order to better fit and or hold and or accommodate the many shapes, sizes, weights, models, makes, styles, etc of hand tools, power tools and other devices & objects (squirt bottles, flashlights, calking guns, hair dry blowers, etc).
(C2)—all of (C1) and further including a lip, reference no 10, bent out at the beginning of the tool hanger and including a bump-out, reference no. 30, whereby creates 2 rounded smooth surface therefore allowing tools, devices, objects to slide and slip along 2 rounded smooth surfaces when being placed down into the belly and hook section, reference no. 20. Thus, making retrieving, replacing, re-retrieving, re-replacing of the tool in use to and from the device carrier/holder easier. Thereby this reduces the chance of miss-placing the tool, device, and object into the device carrier/holder. Therefore, the user is less likely to miss place the tool in use which reduces tools falling and becoming damaged or the work area becoming dangerous from the falling tool, device, object.
(C3)—all of (C1 & C2) and further including the invention device is made of a single continuous material. Whereby such material eliminates parts and pieces from becoming loose, broken, and or having a mechanical failure of the device. Thereby reducing the users concerns for having to replacing their tool carrier/holder, having to use a partial working tool carrier/holder, and having mechanical failure of their tool carrier/holder. Therefore reducing the users fears of the tool holder breaking and dropping the tool and damaging it or the tool falling and hitting another person.
(C4)—all of (C1, C2, & C3) and further having a hanger section, reference no 50, formed whereby the invention device disperses the weight of the tool or device being carried/held. Whereby a person using the device carrier/holder can place the device carrier/holder in additional comfortable, assessable, convenient, and handy places for carrying, accessing, and holding the tools, devices and objects.
(C5)—all of (C1, C2, C3 & C4) and further having the hanger section, reference no 50, large whereby it allows the device to quickly and simply attach and be removed from the many types of devices the user chooses to hang the device carrier/holder from. Like but not limited to belts, pockets, waist bands, tool belts, carpenter aprons, aprons, electrician tool belts, plumber tool belts, tool belt pouches, other professional tradesmen tool belts placed on buckets, cans, ladders, tool boxes, work bench slats, slat wall display walls, and many more objects.
